(19) United States
(12) Patent Application Publication
(10) Pub. No.: US 2019/0287053 A1
(43) Pub. Date: Sep. 19, 2019

(54) SYSTEM FOR PLANNING WHERE TO PLACE MERCHANDISE ITEMS AND METHOD FOR PLANNING WHERE TO PLACE MERCHANDISE ITEMS

(71) Applicant: HITACHI, LTD., Tokyo (JP)

(72) Inventors: Atsushi TOMODA, Tokyo (JP); Masahiko YASUI, Tokyo (JP); Hiromitsu NAKAGAWA, Tokyo (JP)

(73) Assignee: HITACHI, LTD., Tokyo (JP)

(21) Appl. No.: 16/125,331

(22) Filed: Sep. 7, 2018

(30) Foreign Application Priority Data
Mar. 13, 2018 (JP) 2018-044893

(51) Int. Cl. G06Q 10/08; G06Q 10/10

(52) U.S. Cl. CPC G06Q 10/087; G06Q 10/1091; G06Q 10/0833

(57) ABSTRACT

A system for planning where to place merchandise items is configured to create a placement change plan of merchandise; create first virtual work instruction data reflecting a shipment frequency prediction of merchandise on work instruction data relevant to past shipment of merchandise and second virtual work instruction data with placement of merchandise reflecting a placement change plan of merchandise; calculate a predicted value of reduction in shipment working hours from the first and second virtual work instruction data; calculate placement change working hours to perform a placement change plan of merchandise; subtract the placement change working hours from the predicted value of reduction in shipment working hours, thus obtaining a difference; and adopt a placement change plan of merchandise if the difference fulfills a condition of being at or above a certain threshold which is positive or review the placement change plan of merchandise unless fulfilling the condition.

### CROSS-REFERENCE TO RELATED APPLICATIONS

The present application claims priority to Japanese Patent Application No. 2018-044893, filed Mar. 13, 2018. The contents of this application are incorporated herein by reference in their entirety.

### TECHNICAL FIELD

The present invention relates to a system for planning where to place merchandise items and a method for planning where to place merchandise items in a distribution warehouse to support designing a warehouse and work therein.

### BACKGROUND ART

In physical distribution, between manufacturing sites and retailers or consumers, a distribution warehouse is established to receive products from multiple manufacturing sites and select and ship required merchandise items to multiple retailers or multiple consumers in the case of mail-order or online shopping transactions and the like. Also, in some situations, a physical distribution management system may be introduced to perform handling such as giving instructions for actual shipment work and placing orders based on order details from retailers or consumers.

Recently, small-quantity and wide-variety merchandise items have become to be handled in a distribution warehouse, whereas bounded delivery time from order to delivery has become very short. Therefore, it is required to make warehouse operations efficient with limited working personnel and in a limited warehouse area. Actually required working hours differ according to the layout of shelves and passages inside a warehouse, a method of placing merchandise items on the shelves, and a sequence of performing shipment work among others and, therefore, it is needed to design to implement these operations efficiently.

For instance, it is known that, even for a warehouse that handles a great quantity of merchandise items, hot-selling items are usually about 20% of the total of merchandise items and account for 80% of the entire shipment amount. Meanwhile, inside a warehouse, for items being in a place that is near to a doorway of the warehouse, their moving distance for shipment is short and time it takes to collect items for shipment can be reduced. In consideration of these matters, in Patent Literature 1, disclosed is an invention that creates a past shipment ranking from past shipment records and presents a placement plan of placing top 20%, high-ranking merchandise items as near a warehouse doorway as possible.

### CITATION LIST

### Patent Literature

Patent Literature 1: Japanese Unexamined Patent Application Publication No. 2002-288248

### SUMMARY OF INVENTION

### Technical Problem

In an operating distribution warehouse, however, working hours for changing the placement of merchandize items (merchandise item placement change working hours) arise, differently from an initial design of the distribution warehouse, according to the number of merchandize items relocated. Hence, in consequence of changing the placement of merchandise items, even when working hours for shipment have been reduced, when a large quantity of merchandise item placement change working hours arises, the effect of reducing total working hours by summing up both may decrease or go negative in some situations. Therefore, there was a need to present an optimum placement of merchandise items taking account of cost related to changing the placement of merchandise items, not only reducing the working hours for shipment.

In addition, the shipment amount and the shipment ranking changes in time series. Even in a system disclosed in Patent Literature 1, a user is allowed to change the placement of merchandise items appropriately. But, because changing the placement of merchandise items also generates cost, it is not necessarily efficient to move high-ranking items in the shipment ranking to a location where items are easy to pick, following this shipment ranking in each case. Therefore, there was a need to present an optimum placement of merchandise items based on an effective period of the placement of merchandise items once performed and prediction as to how the shipment ranking will vary for that period.

Moreover, in predicting the working hours of shipment work and merchandise item placement change work, a variation arises due to an uncontrollable external factor such as a worker's attribute and an actual work rate. Therefore, there was a need to determine an effect-to-cost ratio including this variation and present placement plans of merchandise items depending on tolerance of variation in work, allowing a user to make a choice. When a warehouse is operating with its handling capability nearly reaching its limit, for example, in busy time, a smaller variation that is predicted is favorable, even though the ratio of the effect of reducing the working hours for shipment to the merchandise item placement change working hours is rather low, as compared with a case where the effect-to-cost ratio is high, but the variation is large. This is because a large variation could result in a risk that shipment work does not finish by the time limit of shipment, as the effect of reducing the working hours for shipment becomes less than an average to a large extent according to circumstances and the handling capability of the warehouse is exceeded. On the other hand, in a quiet season, it is desired that a plan in which more effect can be expected, even though the variation is large, can be chosen.

### Solution to Problem

A system for planning where to place merchandise items in a distribution warehouse, pertaining to the present invention, is characterized by including: a merchandise item placement change creation unit which creates a placement change plan of merchandise items based on merchandise item placement data inside a distribution warehouse; a work plan creation unit which creates first virtual work instruction data reflecting a shipment frequency prediction of merchandise items on work instruction data relevant to past shipment of merchandise items and second virtual work instruction data with placement of merchandise items reflecting a placement change plan of merchandise items; a shipment working hours prediction unit which calculates a predicted value of reduction in shipment working hours based on prediction of the shipment working hours with respect to each of the first virtual work instruction data and the second virtual work instruction data; a placement change working hours prediction unit which calculates placement change working hours to perform a placement change plan of merchandise items; and a control unit which subtracts the placement change working hours from the predicted value of reduction in shipment working hours, thus obtaining a difference, and determines to adopt a placement change plan of merchandise items if the difference fulfills a condition of being at or above a certain threshold which is positive or determines to review the placement change plan of merchandise items unless fulfilling the condition.

### Advantageous Effects of Invention

According to the present invention, it would become possible to present optimum placement plans of merchandise items taking account of working hours to perform placement change of merchandise items and shipment frequency of each merchandise item changing over time, in addition to shipment working hours, and allow a user to makes a choice. Moreover, a user is allowed to choose an optimum placement plan of merchandise depending on tolerance of variation in prediction items.

### BRIEF DESCRIPTION OF DRAWINGS

FIG. 1 is a diagram depicting equipment architecture regarding a system for planning where to place merchandise items pertaining to an embodiment of the present invention.

FIG. 2 is a block diagram depicting the system for planning where to place merchandise items viewed from a functional aspect.

FIG. 3 is a diagram depicting one example of physical placement inside a distribution warehouse.

FIG. 4 is a diagram depicting one example of merchandise item placement data that is managed by the system for planning where to place merchandise items.

FIG. 5 is a diagram depicting one example of work instruction data that is managed by the system for planning where to place merchandise items.

FIG. 6 is a diagram depicting one example of work record data of a warehouse that is managed by the system for planning where to place merchandise items.

FIG. 7 is a diagram representing a flowchart of a process that is performed by the system for planning where to place merchandise items.

FIG. 8 is a diagram depicting two examples of an optimization parameter input screen.

FIG. 9 is a diagram depicting one example of a shipment frequency prediction input screen.

FIG. 10 is a diagram depicting one example of an effect output screen with graphs displayed therein.

FIG. 11 is a diagram depicting one example of an effect output screen with graphs displayed therein, taking variation into account.

FIG. 12 is a diagram depicting one example of a placement change plans output screen.

FIG. 13 is a diagram depicting one example of a process of creating virtual work instruction data.

FIG. 14 is a diagram depicting one example of virtual work instruction data.

FIG. 15 is a diagram depicting one example of virtual work instruction data when applying placement change is in process.

FIG. 16 is a diagram depicting one example of virtual work instruction data after applying placement change.

### DESCRIPTION OF EMBODIMENTS

Embodiments for carrying out the invention will be described below with the aid of the drawings.

### Embodiment

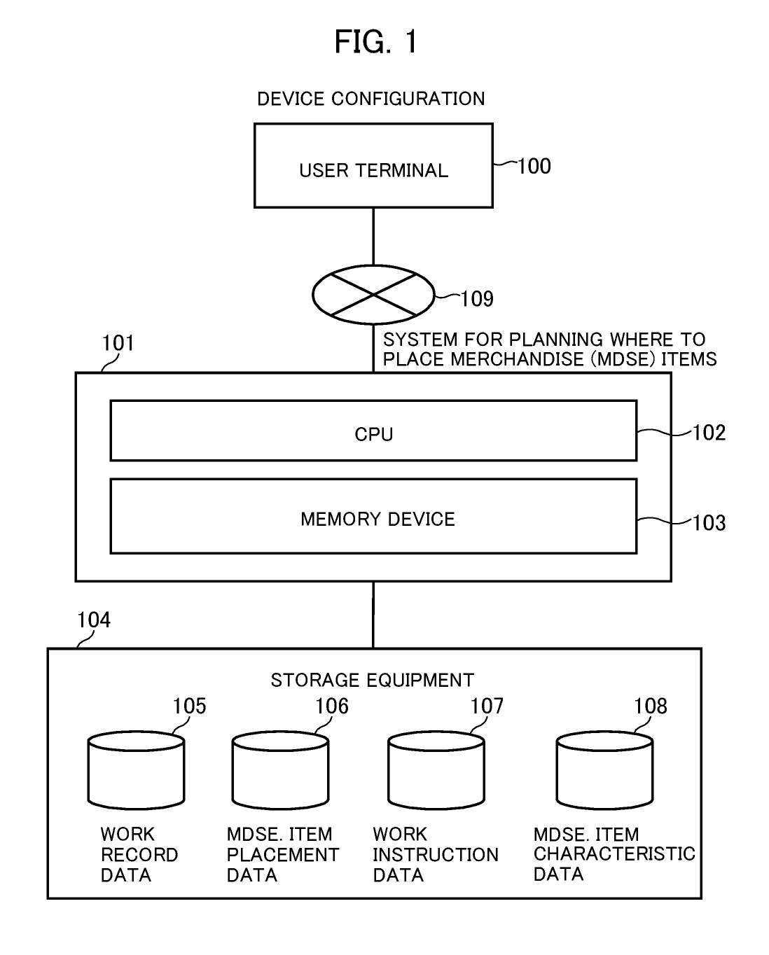

FIG. 1 is a diagram depicting equipment architecture regarding a system for planning where to place merchandise items pertaining to an embodiment of the present invention.

The system 101 for planning where to place merchandise items is comprised of a CPU 102 and a memory device 103 and is connected with a user terminal 100 through a network 109. The system 101 for planning where to place merchandise items runs as a program residing in the memory device 103, but a limitation to this configuration is not necessarily intended for example, a part of the system may be implemented by dedicated circuits.

Storage equipment 104 is also connected to the system 101 for planning where to place merchandise items. In the storage equipment 104, work record data 105, merchandise item placement data 106, work instruction data 107, and merchandise item characteristic data 108 are stored. In FIG. 1, an example is presented in which data that is needed by the system 101 itself for planning where to place merchandise items is stored in the storage equipment 104; however, the system for planning where to place merchandise items does not need to manage such data by itself. Such data that is managed by a general physical distribution management system may be acquired from another site or the like via the network 109.

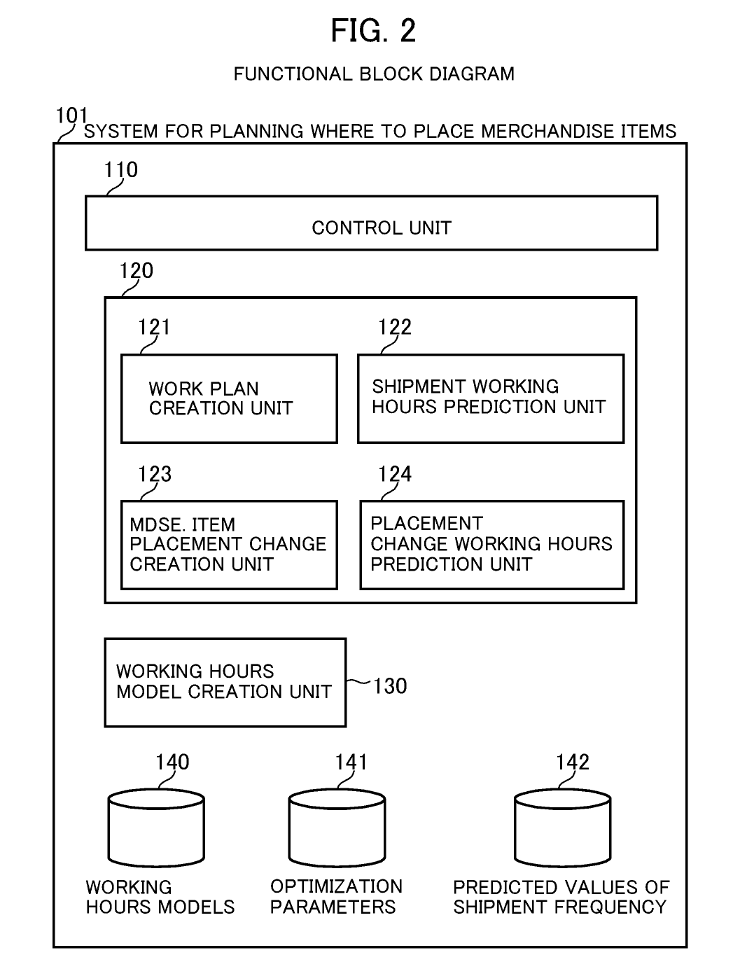

FIG. 2 is a block diagram depicting the system 101 for planning where to place merchandise items viewed from a functional aspect.

The system 101 for planning where to place merchandise items is comprised of a control unit 110 which executes a process of planning where to place merchandise items in response to input/output from a user, an optimization unit 120 which performs optimizing a placement plan of merchandise items, and a working hours model creation unit 130 which creates working hours models 140 for use in the optimization. Also, the system internally retains optimization parameters 141 accepted from a user and predicted values of shipment frequency 142 in addition to the foregoing working hours models 140.

The optimization unit 120 is comprised of a work plan creation unit 121, a shipment working hours prediction unit 122, a merchandise item placement change creation unit 123, and a placement change working hours prediction unit 124.

The working hours model creation unit 130 creates in advance a working hours model 140 from the past work record data 105, merchandise item placement data 106, work instruction data 107, and merchandise item characteristic data 108, as presented in FIG. 1. Taking the work instruction data 107 and the work record data 105 as input data, this unit outputs a predicted value of shipment working hours with respect to instructed work details as a working hours model 140.

In addition, a working hours model 140 may be created through approximation which is performed in advance using a method, such as, e.g., regression analysis with regard to the following data: a worker's moving distance and the number and quantity of merchandise items to pick which will result when a worker will perform work details described in the work instruction data 107; values of, inter alia, weight and size of merchandise items recorded in the merchandise item characteristic data 108, and a value of working hours it takes to perform work as specified by the work instruction recorded in the work record data 105. Moreover, a method based on simulation may be adopted to obtain prediction with a higher accuracy than this working hours prediction.

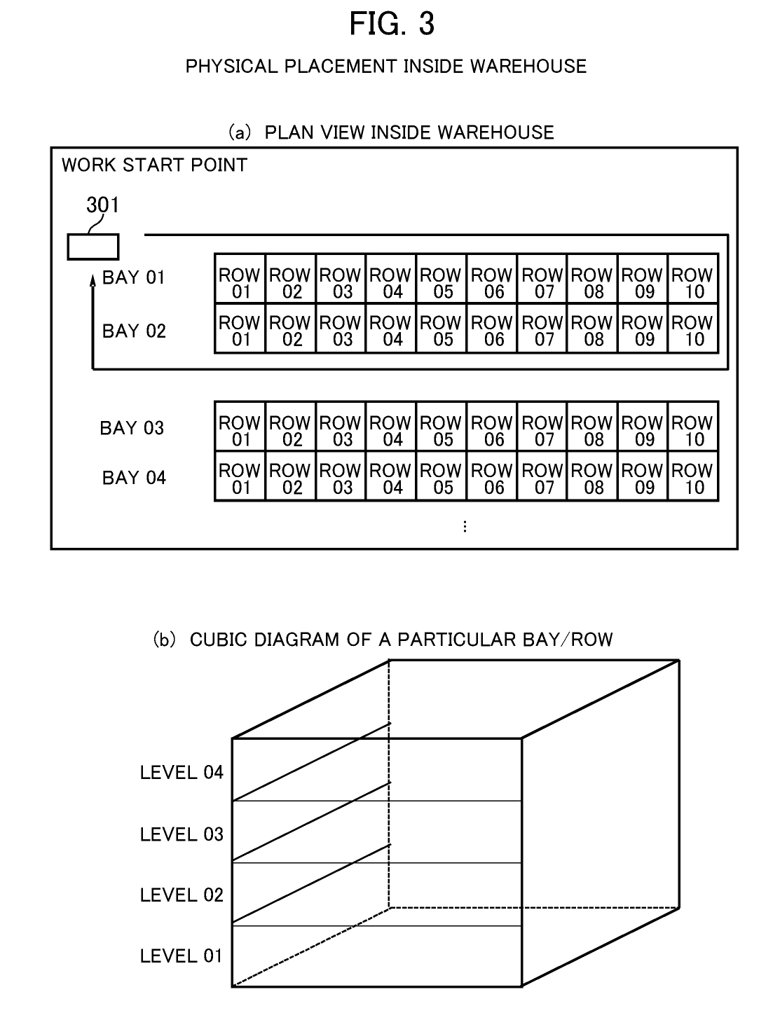

FIG. 3 is a diagram depicting one example of physical placement inside a distribution warehouse; (a) is one example of a plan view inside the warehouse and (b) is one example of a cubic diagram of a particular bay and row.

Multiple shelves are arrayed inside a distribution warehouse and merchandise items can be shelved on and taken out from a shelf from a passage that the shelf faces. As depicted in FIG. 3(a), in bay 01, ten shelves are arrayed in order of row 01, row 02, and up to row 10, facing a passage and, likewise, ten shelves are arrayed also in bay 02, bay 03, and bay 04 respectively. In a distribution warehouse, a work start point 301 is usually provided and a worker picks merchandise items to be shipped as instructed by dropping round the shelves on which the merchandise items are shelved. Also, one row is usually divided into multiple levels and an example in which a row is divided into four levels 01 to 04 is presented in FIG. 3(b).

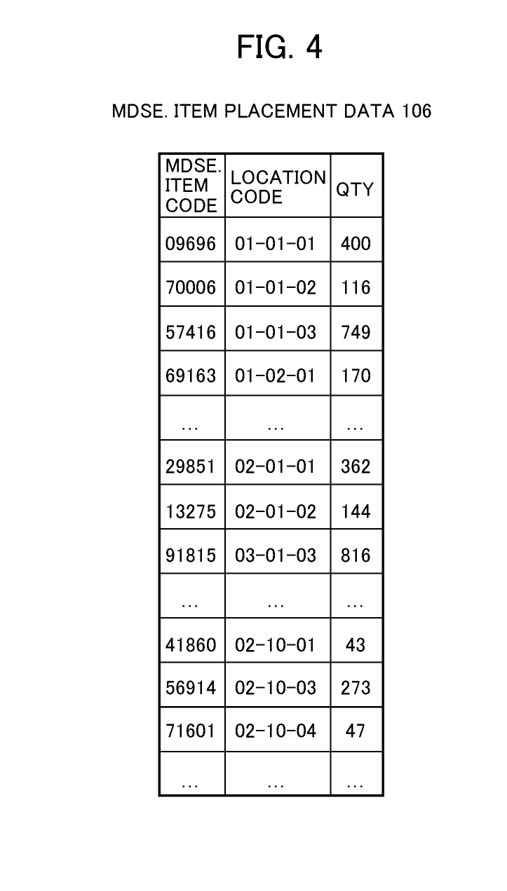

FIG. 4 is one example of merchandise items placement data 106 that is managed by the system for planning where to place merchandise items.

Merchandise items that are treated in a distribution warehouse are assigned merchandise item codes and, for each merchandise item, the merchandise item code of the merchandize item, a location code denoting a location where the merchandise item is shelved, and a quantity of pieces of the merchandise item shelved are managed as the merchandise item placement data 106. By way of example of the merchandise item placement data 106 as presented in FIG. 4, 400 pieces of a merchandise item with merchandise item code “09696” are shelved in a location denoted by location code “01-01-01”. Here, the location code “01-01-01” represents that, in one example of physical placement as presented in FIG. 3, the merchandise item is shelved in level 01 of a shelf specified by bay 01 and row 01.

In the present embodiment, units that are managed with the merchandise item placement data 106 can uniquely be identified by merchandise item code; however, in some warehouses, even the same merchandise item, but with differing production lots or expiration dates among others, may be regarded as different ones and such item may have to be differentiated in management. In that case, the merchandise item placement data is also modified to manage production lot or expiration date as well in addition to merchandise item code.

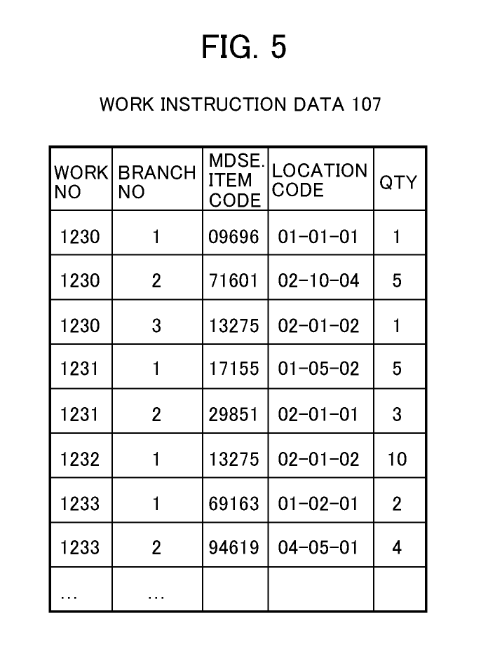

FIG. 5 is one example of work instruction data 107 that is managed by the system for planning where to place merchandise items.

The work instruction data 107 is created to represent details of work instructions in a distribution warehouse depending on order details from retailers or consumers among others. Practically, shipment work is divided per shipment destination or shipment destination group and one worker usually performs one part of shipment work.

As represented in the example as presented in FIG. 5, for example, work No. “1230” has three lines in total as work instruction data and each line is assigned a branch number of “1”, “2”, and “3”. Details of this work instruction data is as follows. First, for branch number “1”, pick one piece of a merchandise item with merchandise code “09696” from a location denoted by location code “01-01-01”. Then, for branch number “2”, pick two pieces of a merchandise item with merchandise code “71601” from a location denoted by location code “02-10-04”. Finally, for branch number “3”, pick one piece of a merchandise item with merchandise code “13275” from a location denoted by location code “02-01-02”.

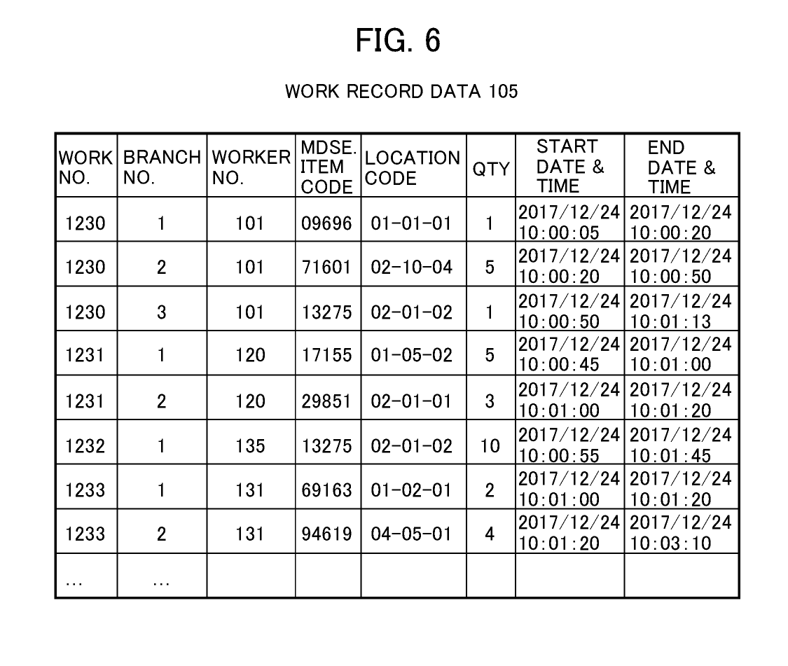

FIG. 6 is one example of work record data 105 of a warehouse that is managed by the system for planning where to place merchandise items.

A worker performs shipment work sequentially based on work instruction data 107 as presented in FIG. 5. In doing so, the worker performs picking work using a handy terminal or the like and each operation of picking a merchandise item is recorded through the handy terminal or the like; thus, its related data including time and others is recorded in the system. Thus, the ID of a worker who performed the work the start date and time and the end date and time of the work are input to the work instruction data 107.

In the example as presented in FIG. 6, for example, the work record data 105 of work No. “1230” represents that, for work branch number “1”, a worker with worker ID “101” picked one piece of a merchandise item with merchandise item code “09696” from a location denoted by location code “01-01-01”, starting at “10 o'clock, 00 min., 05 sec. on 12/24/2017” and ending at ““10 o'clock, 00 min., 05 sec.” on the same day. In addition, when performing work practically in a warehouse y, such a situation could happen that picking order changes not following branch number order specified in the work instruction data 107 or a worker picks a different number of pieces of an item from a location denoted by a different location code. For this reason, entry items such as “location code in actual performance” and “quantity in actual performance” may be added to these entry items.

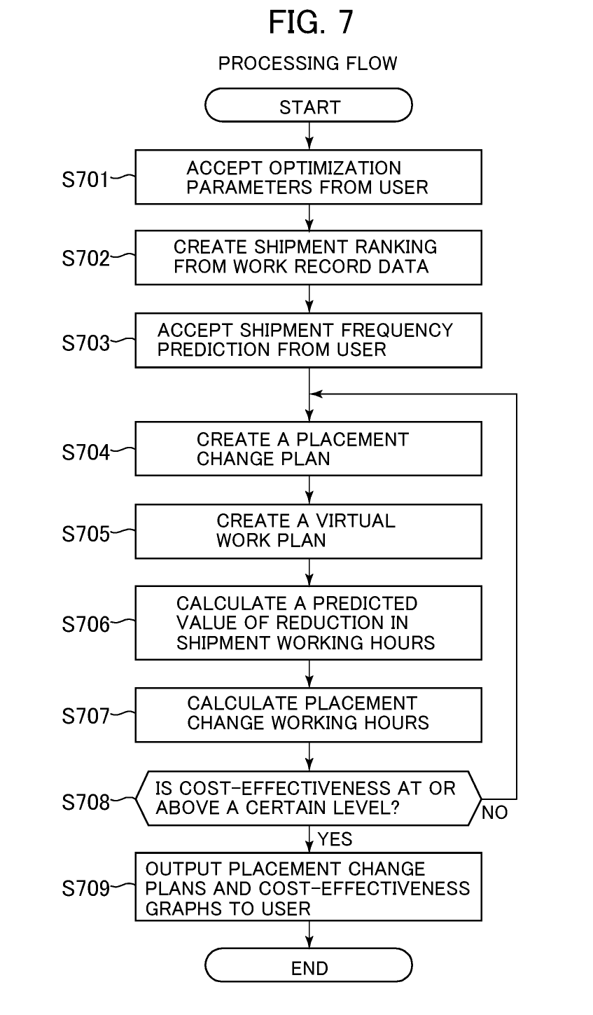

FIG. 7 is a diagram representing a flowchart of a process that is performed by the system for planning where to place merchandise items.

When making a plan for changing the placement of merchandise items, the control unit 110 (FIG. 2) of the system 101 for planning where to place merchandise items operates based on this flowchart.

### (1) Step 701 (S701)

As a first step, the control unit 110 accepts optimization parameters from a user.

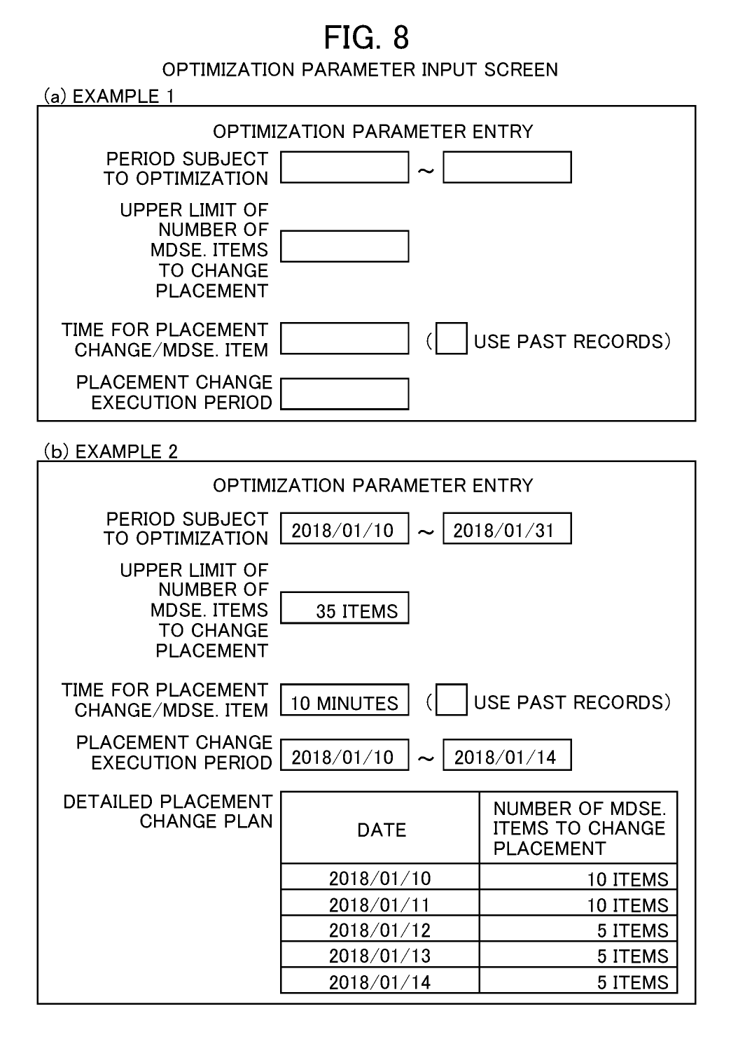

The user inputs optimization parameters using an optimization parameter input screen. FIG. 8 is a diagram depicting two examples of the optimization parameter input screen.

An input screen depicted as “Example 1” in FIG. 8(a) accepts, as entries, each of the following: a period for which optimization should apply (period subject to optimization); an upper limit of the number of merchandise items to change the placement of merchandise items (upper limit of the number of merchandise items to change placement); working hours per merchandise item to change the placement of merchandise items (time for placement change/merchandise item); and a period for which changing the placement of merchandise items is executed (placement change execution period). In addition, as for the work hours per merchandise item to change the placement of merchandise items, it is possible to obtain and use an average value from, e.g., the past work record data 105; the screen may be adapted to accept an option as to whether to use the past work record data 105.

An input screen depicted as “Example 2” in FIG. 8(b) allows the user to further input details of the number of merchandise items to change placement for each date within the placement change execution period as a detailed plan to change placement of merchandise items (detailed placement change plan), not only an upper limit number in total with regard to the upper limit number of merchandise items to change placement. This enables it to reflect a placement change execution plan according to the degree of how busy the work is by day of week, e.g., as in the figure (dates from “01/10/2018” to“01/14/2018”.

### (2) Step 702 (S702)

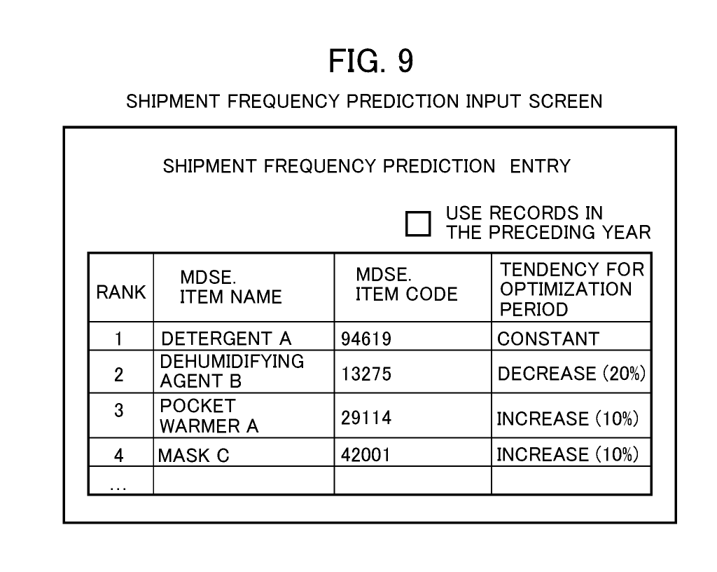

The control unit creates a shipment ranking from the work record data 105. Using the work record data 105, e.g., for the last one week or the last one month, a shipment ranking can be determined by summing up the number of lines of data and the merchandise item quantity per merchandise code described in the work record data 105. The control unit 110 displays merchandise items ranked according to the shipment ranking in a shipment frequency prediction input screen which is depicted in FIG. 9. In an example as presented in FIG. 9, “detergent A” with merchandise item code “94619” is rank No. 1 of shipment frequency (in the “Rank” field in FIG. 9).

### (3) Step 703 (S703)

The control unit 110 accepts input of a shipment frequency prediction (a tendency for the optimization period) from the user as a tendency of shipment frequency for the period subject to optimization for each of the merchandise items (merchandise item codes) displayed on the shipment frequency prediction input screen. For example, for “detergent A” which is rank 1 of shipment frequency ranking, if the user predicts that the shipment frequency will go constant, as compared with past records based on past statistics or the like, the user would enter a string “constant”. For other merchandise items (merchandise item codes), if their shipment frequency for the period subject to optimization is predicted to increase or decrease, the user can enter a string “increase” or “decrease” including how much it will increase or decrease (e.g., “10%” as in the relevant drawing). Now, because this entry (a tendency for the optimization period) is purely a predicted value, an additional field allowing entry of a degree of certainty, variation, etc. may be provided. Additionally, by referring to the work record data 105 for the corresponding period in the preceding year (checking a checkbox “Use records in the preceding year as presented in FIG. 9), it is also possible to predict a tendency of shipment frequency for the period subject to optimization (a tendency for the optimization period).

### (4) Step 704 (S704)

The merchandise item placement change creation unit 123 selects merchandise items from the merchandise item placement data 160 and creates a placement change plan of merchandise items in which location code exchanging is done among a group of selected merchandise items.

### (5) Step 705 (S705)

The work plan creation unit 121 creates virtual work plan data based on past work instruction data 107 and the shipment frequency prediction accepted at step 703 (S703).

Here, one example of a method for creating virtual work instruction data as a virtual work plan is described.

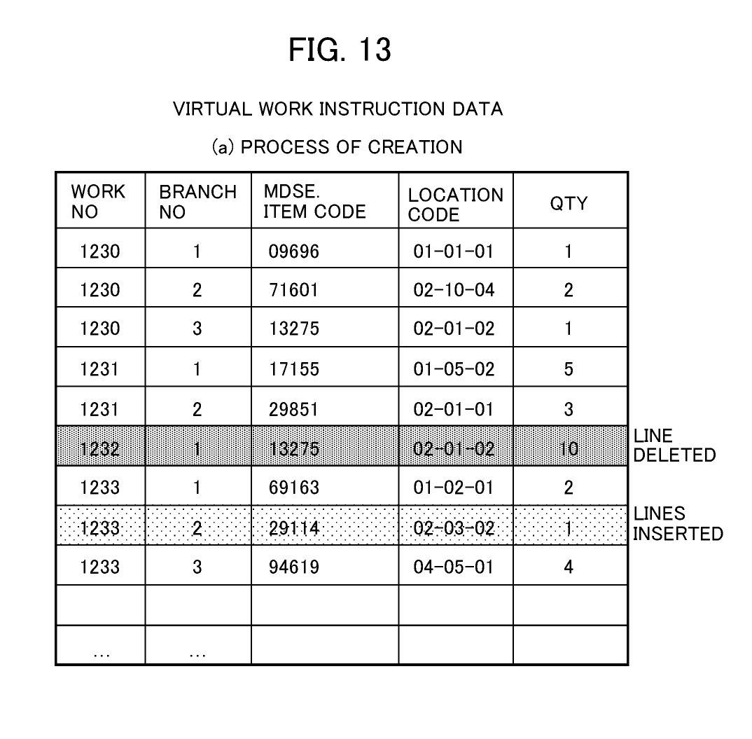

FIG. 13 is a diagram depicting one example of a process of creating virtual work instruction data as “(a) process of creation”. Based on the shipment frequency prediction accepted from the user at step 3 (S703) or the shipment frequency prediction determined with reference to the work record data 105 for the corresponding period in the preceding year, as for a merchandise item for which shipment frequency was predicted to increase, a new line of an instruction to pick the merchandise item is inserted in past work instruction data 107 according to a ratio of the increase. Conversely, as for a merchandise item for which shipment frequency was predicted to decrease, a line of an instruction to pick the merchandise item is deleted from the past work instruction data 107. In virtual work instruction data created by this manipulation, the shipment frequency prediction which was input at the foregoing step 703 (S703) is reflected in the virtual work instruction data.

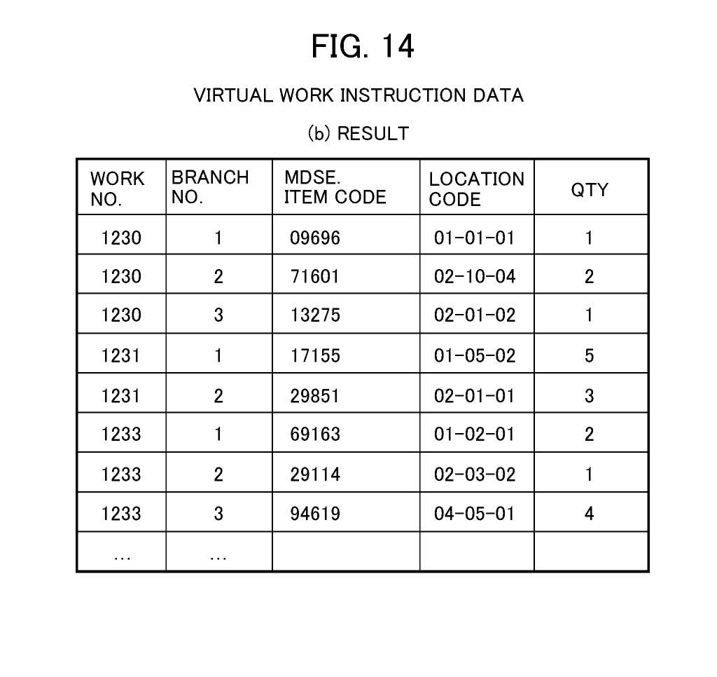

In one example as presented in FIG. 13, for example, as for a merchandise item (with merchandise item code “29114”) entered by the user with a prediction that shipment frequency increases, a line of an instruction to pick the item is inserted. On the other hand, as for a merchandise item (with merchandise item code “13275”) specified by the user with a prediction that shipment frequency decreases, the line of the item is deleted to remove the item from objects of picking as instructed (see the work instruction data 107 as presented in FIG. 5). As a result of such processing, virtual work instruction data reflecting the shipment frequency prediction is obtained, as presented in “(b) result” in FIG. 14.

Furthermore, when a placement change plan of merchandise items is given, it has an effect of shipment work. In fact, when placement of merchandise items is changed, the locations of the respective merchandise items to be picked, described in work instruction data 107, are changed. However, because a sequential order of picking is defined for the locations, the sequential order of picking may be reversed when the locations are changed.

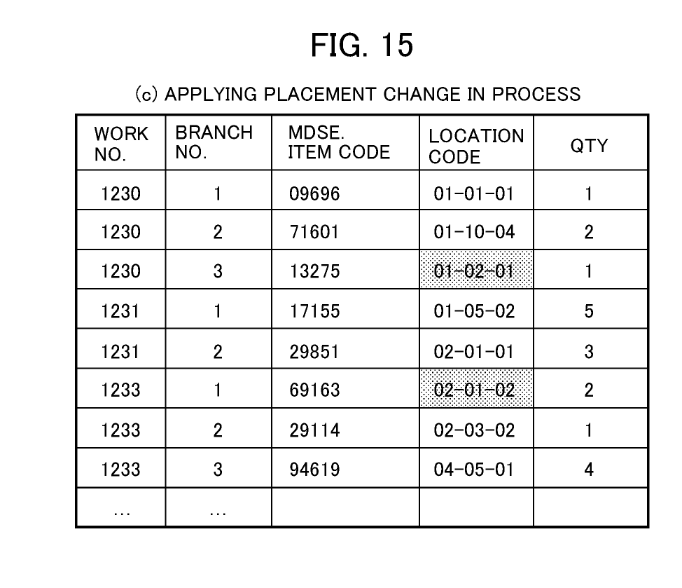

For instance, let us suppose that a placement change plan was given in which, as for a merchandise item with merchandise item code “13275” placed on a shelf specified by location code “02-01-02” and a merchandise item with merchandise item code “69163” placed on a shelf specified by location code “01-02-01”, their shelved locations should be exchanged (see the work instruction data 107 as presented in FIG. 5). In that case, the location codes of the locations from where these merchandise items are to be picked are changed in the work instruction data 107 adaptively to the placement change plan, as presented in “(c) applying placement change in process” in FIG. 15 (the location codes associated with the merchandise item codes subject to the placement change plan are hatched in FIG. 15).

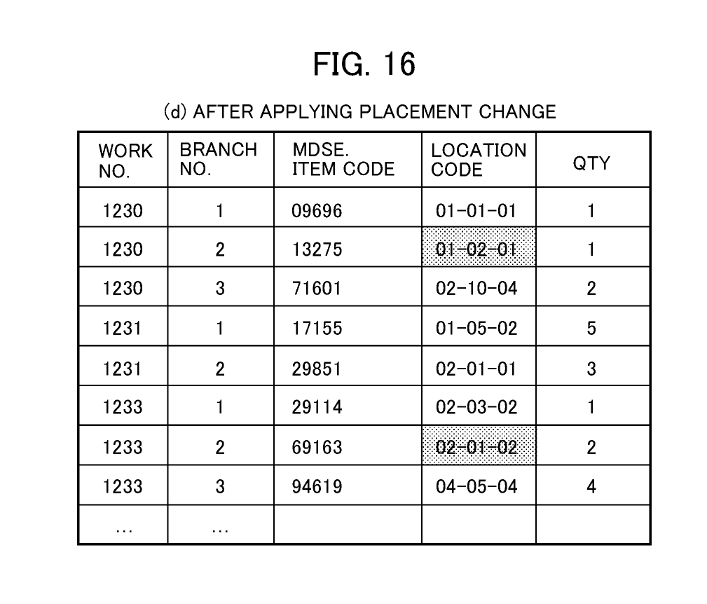

Moreover, exchanging of data in lines occurs in relation to the sequential order of picking, as presented in “(d) after applying placement change” in FIG. 16. In fact, when the location codes of the locations from where the merchandise items are to be picked are only rewritten based on the placement change plan, it follows that, in work No. “1230”, a merchandise item with merchandise item code “09696” is picked from a location denoted by location code “01-01-01”, then a merchandise item with merchandise item code “71601” is picked from a location denoted by location code “02-10-04”, and finally a merchandise item with merchandise item code “13275” is picked from a location denoted by location code “01-02-01”.

But, a route of picking is defined, as presented in “(a) plan view inside warehouse” under physical placement inside warehouse in FIG. 3 and, following this route, after picking is performed from bay 01, row 01 to bay 01, row 10, picking is progressed from bay 02, row 10 toward bay 02, row 01 in reverse order. Hence, when the foregoing placement change plan is applied, data in line 2 and data in line 3 are to be exchanged according to this route of picking. Also, in work No. “1233”, data in a line of merchandise item code “69163” and data in a line of merchandise item code “29114” are to be exchanged according to the route of picking, as done for work No. “1230”. In this way, virtual work instruction data with the placement of merchandise items reflecting the placement change plan is obtained.

Through the procedure as described above, virtual work instruction data reflecting the shipment frequency prediction and virtual work instruction data with the placement of merchandise items reflecting the placement change plan are created.

### (6) Step 706 (S706)

The shipment working hours prediction unit 122 calculates a predicted value of reduction in shipment working hours. A predicted value of reduction in shipment working hours is obtained by applying the virtual work plan (virtual work instruction data) created at the foregoing step 705 (S705) to the working hours model 140 which was previously created by the working hours model creation unit 130 based on past work record data 105. That is, for each of the virtual work instruction data reflecting the shipment frequency prediction made from the past work instruction data 107 and the virtual work instruction data with the placement of merchandise items reflecting the placement change plan of merchandise items, shipment working hours are predicted using a prediction model of shipment working hours. From the predicted values of shipment working hours for each of the former and latter ones of virtual work instruction data, a predicted value of reduction in shipment working hours is calculated.

### (7) Step 707 (S707)

The placement change working hours prediction unit 124 calculates placement change working hours. The placement change working hours are determined from a product of multiplying the time for placement change per merchandise item, which was input by the user as an optimization parameter at the foregoing step 701 (S701) by the number of merchandise items to change placement in the placement change plan created at step 704 (S704).

Additionally, measures for improving the accuracy of determining the placement change working hours can be taken. As one of the measures for improving same, placement change working hours per merchandise item may be determined by using an average of such working hours obtained from data recorded when placement change work was performed in the past (placement change record data). Furthermore, as another one of the measures for improving same, the following method may be adopted. Time for placement change per merchandise item is actually determined depending on variables such as distance to move a merchandise item for its placement change, amount of stock, and weight and size of a merchandise item. Therefore, these variables that have an effect on the time for placement change are derived using merchandise item placement data 106 and merchandise item characteristic data 108. After that, an approximation formula for calculating the time for placement change based on the placement change record data, taking account of derived variables, is determined in advance and stored in the working hours model 140. When calculating the total time for placement change, a calculation is performed using this approximation formula.

### (8) Step 708 (S708)

The control unit 110 compares the predicted value of reduction in shipment working hours with the placement change working hours calculated through the foregoing steps 704 (S704) to 707 (S707) and determines whether or not cost-effectiveness is at or above a certain level. Specifically, if the placement change working hours are subtracted from the predicted value of reduction in shipment working hours and the thus obtained difference is a positive value (Yes), the placement change plan is adopted; if not so (No), the procedure returns to step 704 (S704) to review and recreate a placement change plan. In addition, as a criterion of determination, instead of a positive value obtained as the difference between the predicted value of reduction in shipment working hours and the placement change working hours, the user may be prompted to set a threshold of the difference in advance and the placement change plan, if it is at or above the threshold, may be adopted.

### (9) Step 709 (S709)

The control unit 110 outputs a placement change plan and a cost-effectiveness graph obtained from the placement change plan to the user terminal 100 to present the adopted placement change plan to the user. Furthermore, the system may develop multiple placement plans, collect a certain number of placement change plans, and output the plans in descending order of cost-effectiveness to provide room for choice so that the user can choose an appropriate placement change plan according to circumstances or the like.

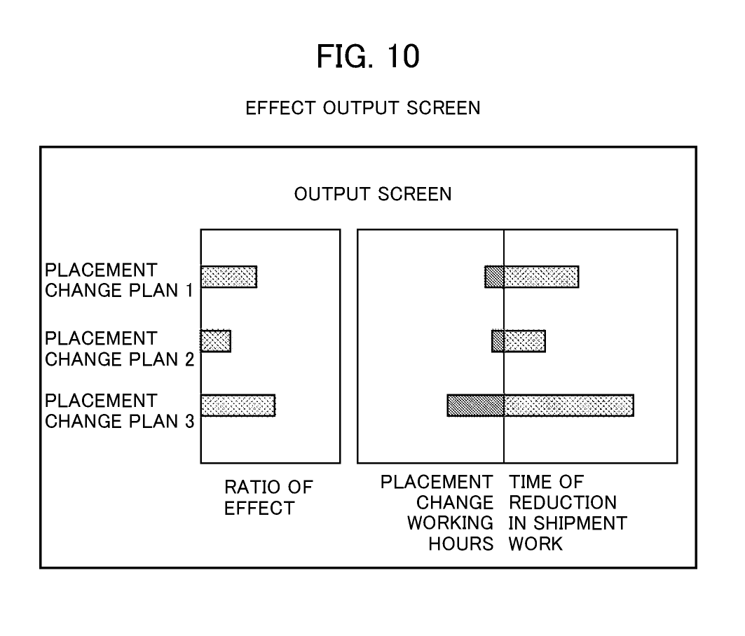

FIG. 10 is a diagram depicting one example of an effect output screen with graphs displayed therein.

For multiple placement change plans collected at the foregoing step 709 (S709), this screen displays a ratio of the effect of each plan and in addition, also displays a predicted value of reduction in shipment working hours (time of reduction in shipment work), which corresponds to the effect, and placement change working hours, which correspond to cost, based on both of which the ratio of effect is determined. FIG. 10 presents an example in which graphs for placement change plans 1 to 3 are displayed.

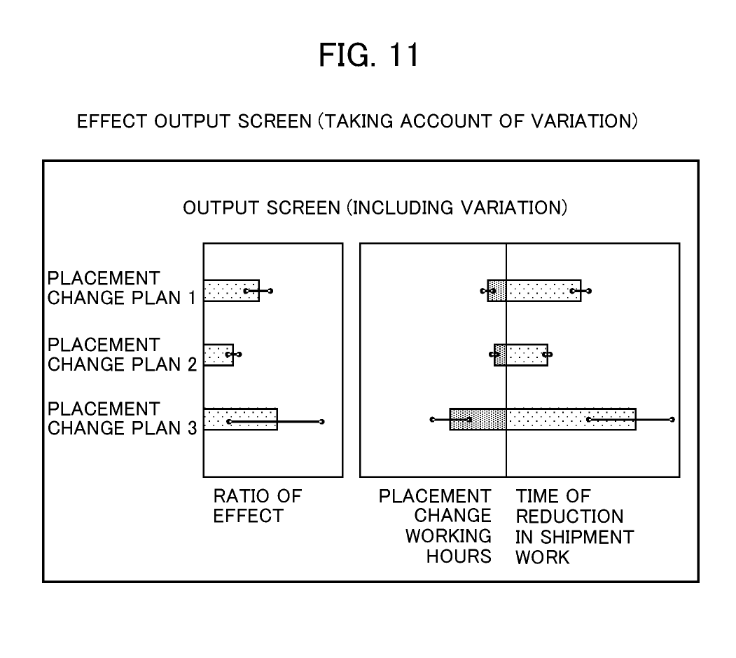

FIG. 11 is a diagram depicting one example of an effect output screen with graphs displayed therein, taking variation into account. Here, “variation” means variation in input values for shipment frequency prediction.

When this variation element is added, a variation that is determined derivatively from the variation element arise in a ratio of effect, placement change working hours, and time of reduction in shipment work; therefore, a range of this variation may be displayed additionally.

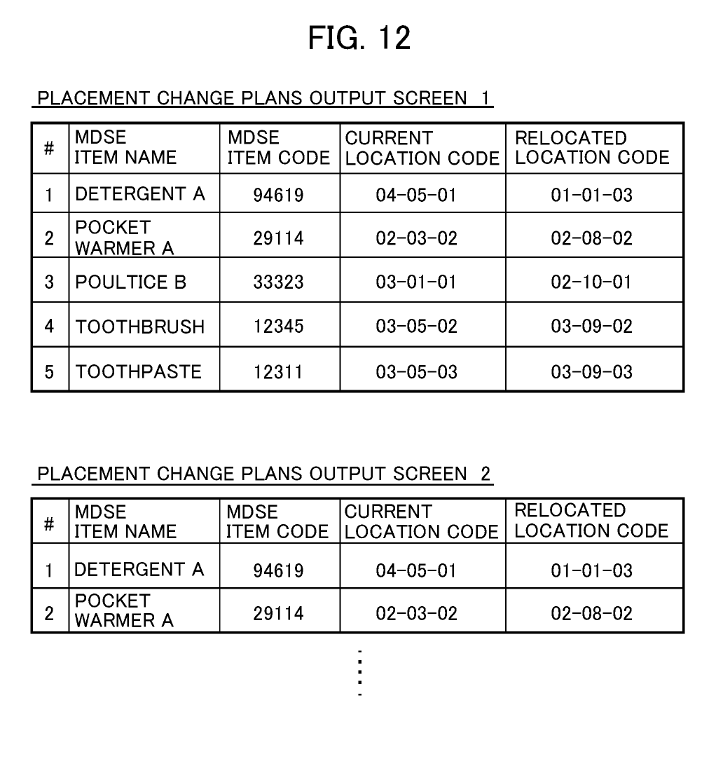

FIG. 12 is a diagram depicting one example of a placement change plans output screen.

This presents output details of placement change plans 1 and 2 among the placement change plans 1 to 3 as presented in FIG. 10 or FIG. 11 referred to previously. For example, the placement change plan 1 has details about changing the locations of five merchandise items and the placement change plan 2 has details about changing the locations of two merchandise items.

In addition, in FIG. 10 referred to previously, a ratio of effect as well as placement change working hours and time of reduction in shipment work for deriving it is output and displayed for each of multiple placement change plans. However, when such ratio is displayed, it is supposed that the same ratio is obtained in one case from cost and effect, both values of which are large and in the other case from cost and effect, both values of which are small. So, the user may be allowed to specify in advance a policy that determines that the ratio obtained in which case should be displayed preferentially.

Furthermore, because cost and effect are purely predicted values, it is supposed that variation arises in the predicted value, inter alia, if the accuracy of prediction is not sufficiently high or if an indeterminable element is included. In FIG. 11, presented is an example of a manner of display taking account of variation and including variation ranges with respect to a ratio of effect, placement change working hours, and time of reduction in shipment work. This makes it possible for the user to make a choice in the way as below: a placement change plan even anticipated to get a high ratio has a risk of actual ratio becoming low if variation is large and, in comparison with the case, the user can choose a placement change plan for which variation is small and the degree of certainty is high, though the ratio is low. That is, the user can choose a placement change plan appropriate for a situation on that occasion from the placement change plan 1 having large cost-effectiveness in terms of placement change working hours vs. time of reduction in shipment work or the placement change plan 2 for which the cost-effectiveness is less, but the load of placement change work is smaller and other plans.

### LIST OF REFERENCE SIGNS

100 . . . User terminal
101 . . . System for planning where to place merchandise items
102 . . . CPU
103 . . . Memory device
104 . . . Storage equipment
105 . . . Work record data
106 . . . Merchandise item placement data
107 . . . Work instruction data
108 . . . Merchandise item characteristic data
109 . . . Network
110 . . . Control unit
120 . . . Optimization unit
121 . . . Work plan creation unit
122 . . . Shipment working hours prediction unit
123 . . . Merchandise item placement change creation unit
124 . . . Placement change working hours prediction unit
130 . . . Working hours model creation unit
140 . . . Working hours model
141 . . . Optimization parameter
142 . . . Predicted value of shipment frequency
301 . . . Work start point

1. A system for planning where to place merchandise items in a distribution warehouse, the system comprising:
a merchandise item placement change creation unit which creates a placement change plan of merchandise items based on merchandise item placement data inside the distribution warehouse;
a work plan creation unit which creates first virtual work instruction data reflecting a shipment frequency prediction of the merchandise items on work instruction data relevant to past shipment of merchandise items and second virtual work instruction data with placement of merchandise items reflecting a placement change plan of the merchandise items;
a shipment working hours prediction unit which calculates a predicted value of reduction in shipment working hours based on prediction of the shipment working hours with respect to each of the first virtual work instruction data and the second virtual work instruction data;
a placement change working hours prediction unit which calculates placement change working hours to perform a placement change plan of the merchandise items; and
a control unit which subtracts the placement change working hours from the predicted value of reduction in the shipment working hours, thus obtaining a difference, and determines to adopt a placement change plan of the merchandise items if the difference fulfills a condition of being at or above a certain threshold which is positive or determines to review the placement change plan of the merchandise items unless fulfilling the condition.

2. The system for planning where to place merchandise items according to claim 1,
wherein the control unit performs a shipment frequency prediction of the merchandise items based on input of the shipment frequency prediction accepted from a user or past work record data.

3. The system for planning where to place merchandise items according to claim 1,
wherein when calculating the placement change working hours based on placement change record data, the placement change working hours prediction unit takes account of weight, size, amount of stock, and moving distance of merchandise items relevant to the placement change plan as variables.

4. The system for planning where to place merchandise items according to claim 1,
wherein the control unit outputs one or more placement change plans of the merchandise items and cost-effectiveness graphs obtained from the placement change plans to a user terminal.

5. The system for planning where to place merchandise items according to claim 4,
wherein the control unit outputs a ratio of effect, placement change working hours, and time of reduction in shipment work as the cost-effectiveness graphs.

6. A method for planning where to place merchandise items in a distribution warehouse, the method comprising:
a first step of creating a placement change plan of merchandise items based on merchandise item placement data inside the distribution warehouse;
a second step of creating first virtual work instruction data reflecting a shipment frequency prediction of the merchandise items on work instruction data relevant to past shipment of merchandise items and second virtual work instruction data with placement of merchandise items reflecting a placement change plan of the merchandise items;
a third step of calculating a predicted value of reduction in shipment working hours based on prediction of the shipment working hours with respect to each of the first virtual work instruction data and the second virtual work instruction data;
a forth step of calculating placement change working hours to perform a placement change plan of the merchandise items; and
a fifth step of subtracting the placement change working hours from the predicted value of reduction in the shipment working hours, thus obtaining a difference, and adopting a placement change plan of the merchandise items if the difference fulfills a condition of being at or above a certain threshold which is positive or reviewing the placement change plan of the merchandise items unless fulfilling the condition and re-executing the first to fourth steps.

7. The method for planning where to place merchandise items according to claim 6,
wherein the second step further comprises performing a shipment frequency prediction of the merchandise items based on input of the shipment frequency prediction accepted from a user or past work record data.

8. The method for planning where to place merchandise items according to claim 6,
wherein the fourth step further comprising calculating the placement change working hours based on placement change record data, taking account of weight, size, amount of stock, and moving distance of merchandise items relevant to the placement change plan as variables.

9. The method for planning where to place merchandise items according to claim 6, further comprising a sixth step of presenting one or more placement change plans of the merchandise items adopted in the fifth step and cost-effectiveness graphs obtained from the placement change plans to a user.

10. The method for planning where to place merchandise items according to claim 9,
wherein the sixth step further comprises presenting a ratio of effect, placement change working hours, and time of reduction in shipment work as the cost-effectiveness graphs.
